(19) United States
(12) Patent Application Publication
(10) Pub. No.: US 2007/0180284 A1
(43) Pub. Date: Aug. 2, 2007

(54) Electronic device and operation control method

(76) Inventor: Hiroyuki Tsuji, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/699,887

(22) Filed: Jan. 30, 2007

(30) Foreign Application Priority Data
Jan. 31, 2006 (JP) 2006-022942

(51) Int. Cl. G06F 1/00

(52) U.S. Cl. 713/323

(57) ABSTRACT

According to one embodiment, there provided an electronic device including a body to which a display unit is detachably connected, the body and the display unit having capabilities of mutually performing wireless communication in a detached state, a processing unit to shift an operation mode of the electronic device to a power-saving mode, and a control unit to inhibit the operation mode of the electronic device from shifting to the power-saving mode when the display unit is detached from the body.

### CROSS-REFERENCE TO RELATED APPLICATIONS

This application is based upon and claims the benefit of priority from Japanese Patent Application No. 2006-022942, filed Jan. 31, 2006, the entire contents of which are incorporated herein by reference.

### BACKGROUND

1. Field

One embodiment of the invention relates to an electronic device including a body to/from which a display unit is attachable/detachable, and a method of controlling the operation of the electronic device to attach or detach the display unit to or from the body.

2. Description of the Related Art

Some electronic devices such as a notebook personal computer are so configured that a display unit can be attached to or detached from a main body and radio communications can be performed between them when they are detached from each other. For example, Jpn. Pat. Appln. KOKAI Publication No. 2003-345463 discloses a notebook computer having a display which can be attached to or detached from the main body of the computer and which operates as a radio tablet personal computer.

Electronic devices of the above type generally have not only a normal mode but also a power-saving mode (sleep mode, hibernation mode, etc.) for reducing power consumption. Most of the electronic devices have a function of shifting an operation mode to a power-saving mode to power off the devices if a user does not perform any input operation for a fixed period of time. This function can prevent useless power consumption.

However, the shift to the power-saving mode will also be effected when the display unit is detached from the main body. Since the electronic device is powered off, communications between the display unit and the main body will be broken unexpectedly. With this communication breakage, a user has to stop his or her operation. It takes time to resume the communications, which decreases the efficiency of the operation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of the outward appearance of a detachable notebook personal computer according to one embodiment of the invention;

FIG. 2 is an exemplary block diagram showing a system configuration of the main body of the computer shown in FIG. 1;

FIG. 3 is an exemplary block diagram showing a system configuration of a display unit of the computer shown in FIG. 1;

FIGS. 4A and 4B are exemplary illustrations of the flow of a signal when the display unit is detached from the main body of the computer;

FIG. 5 is an exemplary block diagram of the functions of the utility shown in FIGS. 4A and 4B;

FIG. 6 is an exemplary diagram showing an example of a basic setting screen set by a setting unit of the utility shown in FIG. 5;

FIG. 7 is an exemplary diagram showing an example of an action setting screen set by the setting unit of the utility shown in FIG. 5;

FIG. 8 is an exemplary flowchart showing a first example of the operation performed when the display unit is detached from the main body of the computer; and

FIG. 9 is an exemplary flowchart showing a second example of the operation performed when the display unit is detached from the main body of the computer.

### DETAILED DESCRIPTION

Various embodiments according to the invention will be described hereinafter with reference to the accompanying drawings. In general, according to one embodiment of the invention, there provided an electronic device including a body to/from which a display unit is attachable/detachable, the body and the display having capabilities of mutually performing wireless communication in a detached state, a processing unit to shift an operation mode of the electronic device to a power-saving mode, and a control unit to inhibit the operation mode of the electronic device from shifting to the power-saving mode when the display unit is detached from the body.

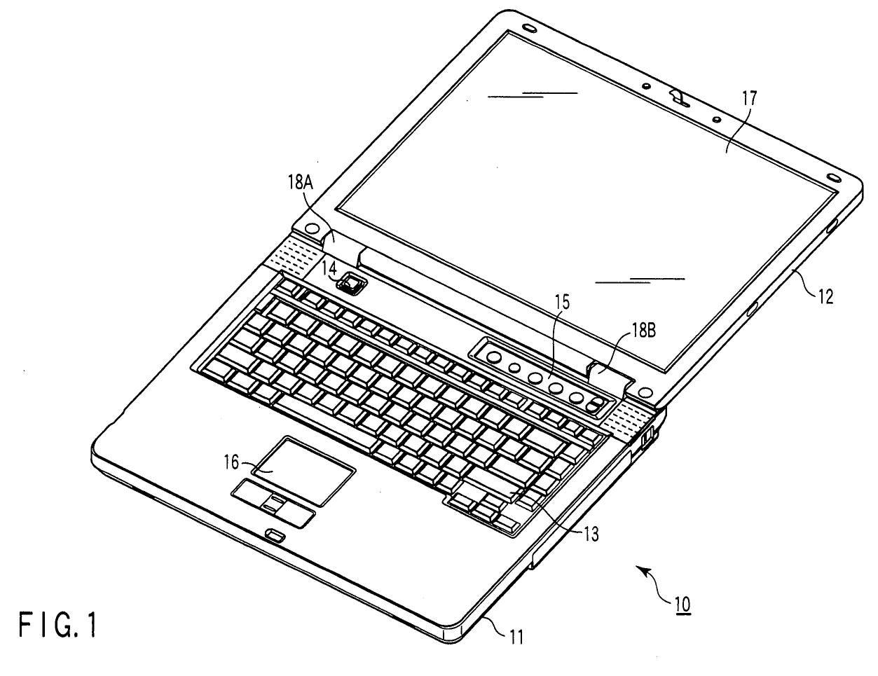

Referring first to FIGS. 1 to 3, the configuration of an electronic device according to the embodiment of the invention will be described. The electronic device is implemented as a battery-operable, detachable notebook personal computer (electronic device) 10.

FIG. 1 is a perspective view of the personal computer 10 whose display unit is open. The computer 10 includes a main body 11 and a display unit 12. The display unit 12 is part of the computer 10. The unit 12 can be detached from the main body 11 and driven independently thereof.

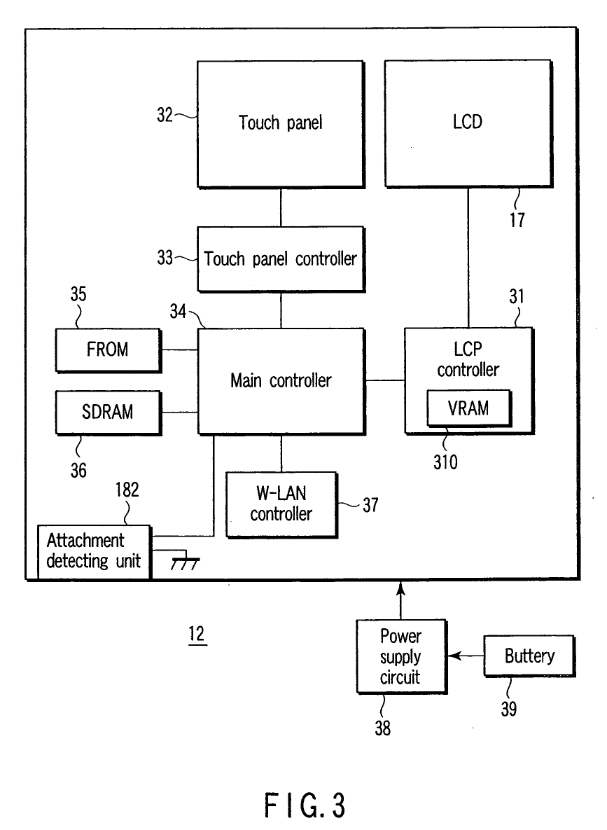

The display unit 12 incorporates a display device having a liquid crystal display (LCD) 17. The display screen of the LCD 17 is located in almost the central part of the display unit 12. A touch panel 32 is mounted, for example, on the front of the LCD 17 (refer to FIG. 3).

The display unit 12 is attached to the main body 11 by hinges 18A and 18B and can be turned between its open position and closed position. The hinges 18A and 18B allow the display unit 12 to be attached to or detached from the main body 11.

The main body 11 is a thin, box-type cabinet. For example, a keyboard 13, a power button 14 for powering on/off the computer 10, an input operation panel 15, and a touchpad 16 are arranged on the top of the main body 11. The input operation panel 15 is an input device for inputting an event corresponding to a depressed button. The panel 15 has a plurality of buttons for starting their respective functions.

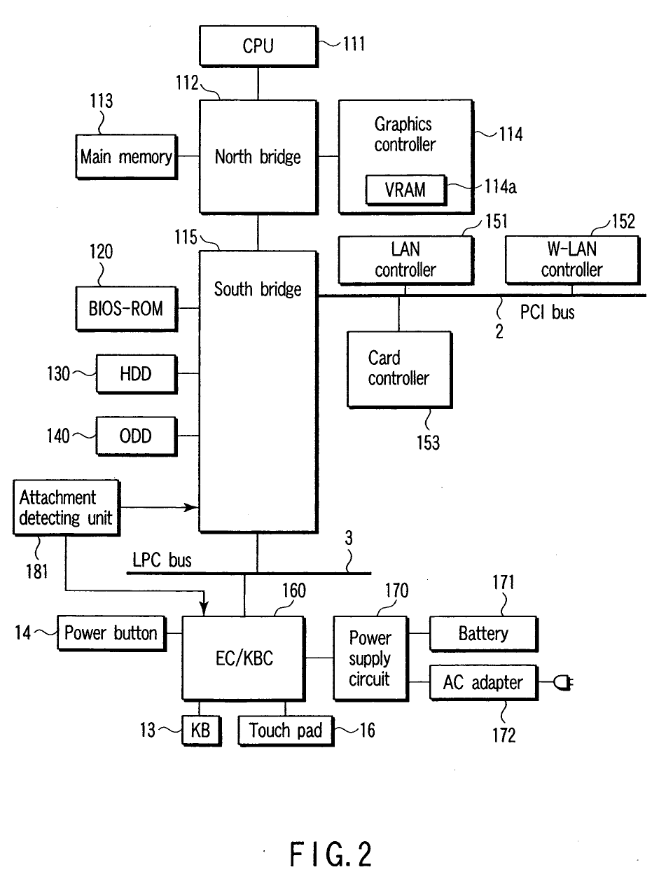

FIG. 2 is a block diagram showing a system configuration of the main body 11 of the computer 10 shown in FIG. 1. The main body 11 has a CPU 111, a north bridge 112, a main memory 113, a graphics controller 114 and a south bridge 115. The main body 11 also has a BIOS-ROM 120, a hard disk drive (HDD) 130, an optical disk drive (ODD) 140, a LAN controller 151, a wireless LAN controller (W-LAN controller) 152, a card controller 153, and an embedded controller/keyboard controller IC (EC/KBC) 160, a power supply circuit 170 and an attachment detecting unit 181.

The CPU 111 is a processor that controls the operation of the computer 10. The CPU 111 performs an operating system (OS) that is to be loaded into the main memory 113 from a boot device such as the HDD 130. The CPU 111 executes various application programs. The CPU 111 also executes a system basic input output system (BIOS) stored in the BIOS-ROM 120. The system BIOS is a program for hardware control.

The north bridge 112 is a bridge device which connects the local bus of the CPU 111 and the south bridge 115. The north bridge 112 incorporates a memory controller that controls access to the main memory 113. The north bridge 112 also has a function of communicating with the graphics controller 114 via an accelerated graphics port (AGP) bus and the like.

The graphics controller 114 is a display controller which controls the LCD 17 used as a display monitor of the computer 10. The graphics controller 114 operates when the display unit 12 is attached to the main body 11 of the computer 10. The graphics controller 114 has a video memory (VRAM) 114a, and generates a video signal for forming a display image from the display data written into the VRAM 114a. The display image is to be displayed on the LCD 17.

The south bridge 115 controls access to the BIOS-ROM 120. The BIOS-ROM 120 is a rewritable nonvolatile memory such as a flash ROM. As described above, the BIOS-ROM 120 stores the system BIOS. The south bridge 115 controls a disk drive (I/O device) such as the HDD 130 and the ODD 140.

The south bridge 115 is connected to a peripheral component interconnect (PCI) bus 2 and a low pin count LPC) bus 3. The south bridge 115 controls each device on the PCI bus 2 and LPC bus 3. The PCI bus 2 is used as a system bus.

The HDD 130 is a storage device which stores various types of software and data. The HDD 130 writes/reads data to/from magnetic recording media (magnetic disk) using a head (magnetic head). The magnetic recording media is rotated by a motor. The HDD 130 stores the operating system (OS) in advance. The OS is loaded into the main memory 113 in accordance with the system BIOS stored in the BIOS-ROM 120 and executed by the CPU 111.

The ODD 140 is a drive unit which rotates optical recording media (optical disc) such as a compact disc (CD) and a digital versatile disc (DVD) through a motor. The ODD 140 reads/writes data from/to the optical disc through a head (optical head).

The LAN controller 151, W-LAN controller 152 and card controller 153 are connected to the PCI bus 2. The LAN controller 151 is a network controller for connecting the main body 11 to a LAN (wire LAN). The W-LAN controller 152 is a network controller for connecting the main body 11 to a wireless LAN. The card controller 153 controls a card device such as a PC card or a secure digital (SD) card, which is inserted into a card slot connected to the card controller 153.

The EC/KBC 160 is a microcomputer in which an embedded controller for managing a power supply and a keyboard controller for controlling, e.g., the keyboard (KB) 13 and the touchpad 16 are integrated on a single chip. The EC/KBC 160 has a power control function of operating in cooperation with the power supply circuit 170 and powering on the computer 10 in response to a user's depression of the power button 14. The power supply circuit 170 generates a system power supply voltage which is to be applied to each of the units of the main body 11, using a DC power supply voltage that is applied via a rechargeable battery 171 or an AC adapter 172 serving as a high-voltage power supply. The AC adapter 172 transforms an AC power supply voltage into a DC power supply voltage.

The attachment detecting unit 181 is used to monitor the state of attachment/detachment of the display unit 12 to/from the main body 11. The unit 181 generates a low-level signal while the display unit 12 is attached to the main body 11, and generates a high-level signal while it is detached therefrom. Such a signal that discriminates between attachment and detachment is transmitted to the BIOS through the EC/KBC 160 or not through the EC/KBC 160. The BIOS is notified of the state of attachment/detachment through a memory means such as a register. If information corresponding to a signal generated from the attachment detecting unit 181 is written to a predetermined register provided in the south bridge 115 or the like, the BIOS reads the information to detect a change of attachment/detachment, and requests the OS to perform a necessary process (e.g., a change in operation mode).

FIG. 3 is a block diagram showing a system configuration of the display unit 12. The display unit 12 includes not only the LCD 17 shown in FIG. 1, but also an LCD controller 31, a touch panel 32, a touch panel controller 33, a main controller 34, a flash ROM (FROM) 35, a synchronous DRAM (SDRAM) 36, a W-LAN controller 37, a power supply circuit 38, a battery 39 and an attachment detecting unit 182.

The LCD controller 31 is a display controller that controls the LCD 17. The LCD controller 31 operates when the display unit 12 is detached from the main body 11 and used independently. The LCD controller 31 has a video memory (VRAM) 310, and generates a video signal for forming a display image from the display data written into the VRAM 310. The display image is to be displayed on the LCD 17.

The touch panel 32 has an input screen that a user touches with his or her finger to indicate the position of the touch. The touch panel 32 is transparent and is mounted, for example, on the front of the LCD 17. The touch-panel controller 33 senses the position on the touch panel 32 which the user has touched with the finger. Thus, the user can directly indicate various menus with the finger under the control of the main controller 34, for example. The menus are displayed on the LCD 17 by the LCD controller 31. The touch panel 32 and touch panel controller 33 can be replaced with, for example, a tablet (digitizer) capable of indicating a position with a pen and a tablet controller (digitizer controller), respectively.

The main controller 34 controls the operation of the whole of the display unit 12. The main controller 34 includes an I/O controller and a CPU that executes various programs stored in the FROM 35, for example. The I/O controller controls the input/output of data to/from the LCD controller 31, touch panel controller 33, W-LAN controller 37 and the like. Part of the SDRAM 36 is used as a work area of the CPU in the main controller 34. In the present embodiment, the programs stored in the FROM 35 include an Internet viewer program (what is called a browser).

The W-LAN controller 37 is a network controller for connecting the display unit 12 to the wireless LAN. The W-LAN controller 37 allows the main controller 34 to operate the display unit 12 as an independent Internet viewer in accordance with the Internet viewer program. The main controller 34 carries out radio communication with the W-LAN controller 152 in the main body 11 through the W-LAN controller 37. The display unit 12 can thus serve as part of the computer 10.

The W-LAN controllers 37 and 152 can be replaced with another wireless communication device such as an ultra-wideband (UWB) wireless controller. If the main body 11 and display unit 12 are electrically connected to each other through a connector, communications can be carried out between the main body 11 and display unit 12 via the PCI bus 2 or the LAN.

The power supply circuit 38 generates a power supply voltage (system power supply voltage) for driving the elements in the display unit 12. While the display unit 12 is attached to the main body 11, the power supply circuit 38 operates in response to a system power supply voltage generated by the power supply circuit 170 of the main body 11. While the display unit 12 is detached from the main body 11, the power supply circuit 38 operates in response to the voltage applied from the battery 39. The battery 39 is a rechargeable one.

The attachment detecting unit 182 is used to monitor the state of attachment/detachment of the display unit 12 to/from the main body 11. The unit 182 generates a low-level signal while the display unit 12 is attached to the main body 11, and generates a high-level signal while it 12 is detached therefrom. Such a signal that discriminates between attachment and detachment is transmitted to the main controller 34, for example.

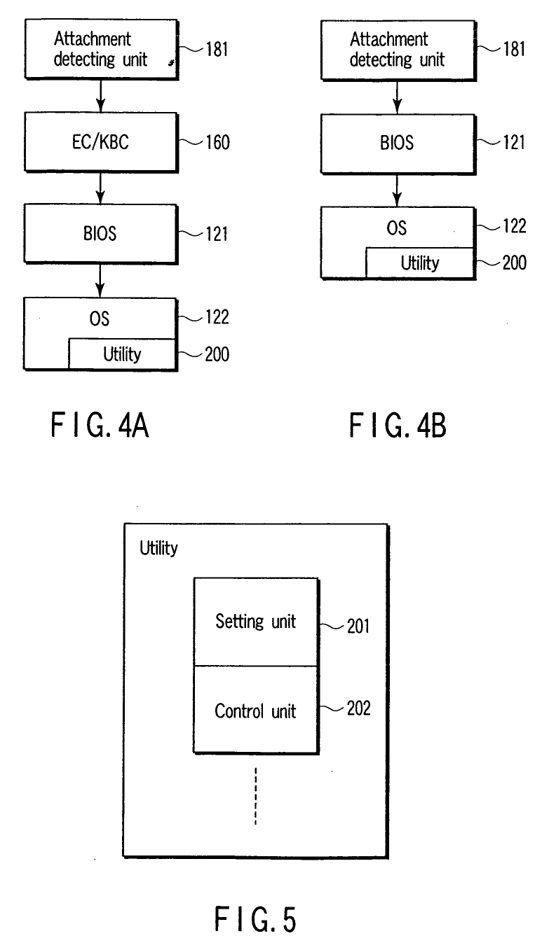

FIGS. 4A and 4B are illustrations of the flow of a signal when the display unit 12 is detached from the main body 11 of the computer 10. FIG. 4A shows a case where the BIOS is notified of attachment/detachment of the display unit 12 through the EC/KBC 160, and FIG. 4B shows another case where it is done not through the EC/KBC 160.

In the case of FIG. 4A, when the attachment detecting unit 181 detects that the display unit 12 is detached from the main body 11, it notifies the EC/KBC 160 of a signal indicative of detachment. Thus, the EC/KBC 160 transmits the signal to the BIOS 121 via a register and the like. If the BIOS 121 reads information out of the register and recognizes a change to the detachment, it notifies the OS of the change and requests an OS 122 to perform a necessary process. The utility 200 managed by the OS 122 performs the necessary process after checking the setting contents of the detachment of the display unit 12.

FIG. 5 is a block diagram of the functions of the utility 200 shown in FIGS. 4A and 4B. The utility 200 includes various functions such as a setting unit 201 and a control unit 202.

The setting unit 201 is a function of setting various items of information that a user inputs through a user interface. The setting unit 201 can designate a mode (e.g., a suspend mode and a hyper mode) to which the operation mode of the computer 10 is shifted when predetermined conditions are met. In particular, the unit 201 can determine whether the operation mode of the computer 10 should be inhibited from shifting to a power-saving mode (e.g., a suspend mode and a sleep mode) when the display unit 12 is detached from the main body 11. If the unit 201 determines that the operation mode is inhibited from shifting to the power-saving mode, it can designate various conditions for the inhibition.

The control unit 202 is a function of performing a necessary process in accordance with the contents set in the setting unit 201. The control unit 202 performs a necessary process to shift the operation mode of the computer 10 to a power-saving mode (e.g., a suspend mode and a sleep mode) when predetermined conditions are met. When the display unit 12 is detached from the main body 11, the control unit 202 inhibits the operation mode from shifting to the power-saving mode depending on the contents set in the setting unit 201. When the unit 202 inhibits the shift to the power-saving mode, an automatic power-off function is disabled. If, therefore, the display unit 21 is detached from the main body 11, the operation mode cannot be shifted to the power-saving mode and thus the computer 10 is not powered off. Consequently, it is possible to prevent communications between the main body 11 and the display unit 12 from being broken unexpectedly. When the display unit 12 is attached to the main body 11, the automatic power-off function is enabled.

The control unit 202 inhibits the operation mode of the computer 10 from shifting to the power-saving mode depending on the contents set in the setting unit 201, if communication (including a polling process) is being carried out between the computer 10 and the display unit 12 when the display unit 12 is detached from the main body 11. The control unit 202 permits the operation mode to shift to the power-saving mode depending on the contents set in the setting unit 201, if no input operation is performed for a fixed period of time or no communication (including a polling process) is performed between the main body 11 and the display unit 12 when the display unit 12 is detached from the main body 11.

Furthermore, the control unit 202 shifts the operation mode of the computer 10 to a mode (e.g., a hyper mode) for improving the performance of the CPU 111 depending on the contents set in the setting unit 201, when the display unit 12 is detached from the main body 11. This prevents communication from being broken and allows good communication to be reliably maintained.

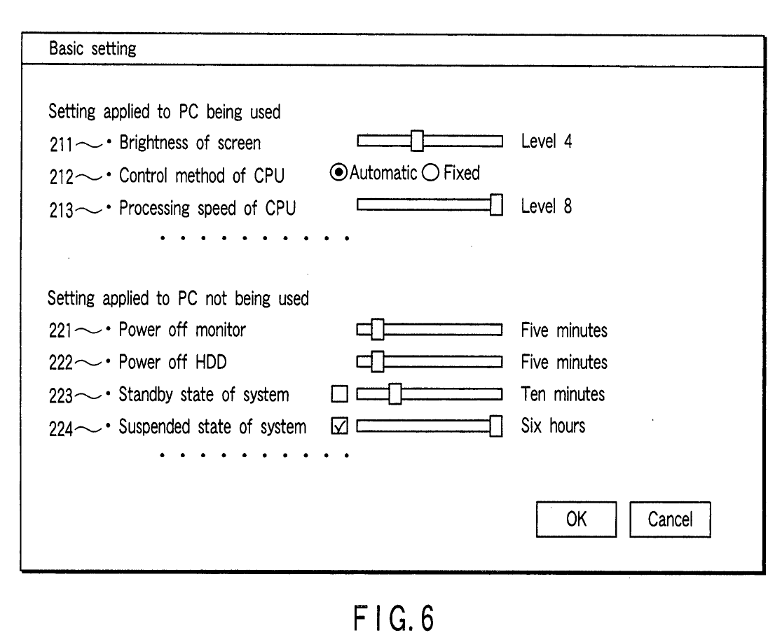

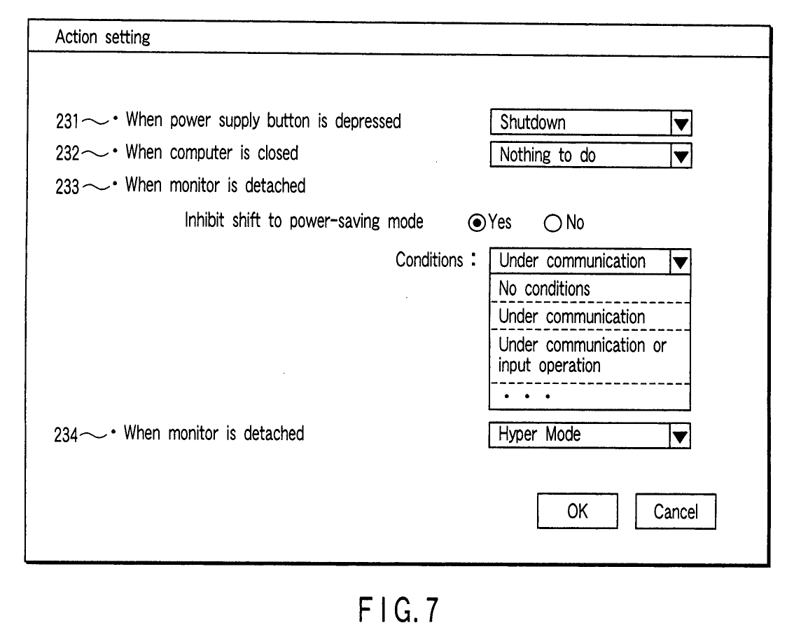

The setting screen set by the setting unit 201 of the utility 200 shown in FIG. 5 will be described with reference to FIGS. 6 and 7. FIG. 6 shows an example of the setting screen for making a basic setting, and FIG. 7 shows another example of the setting screen for performing an action setting (setting of the contents when a user operates various operations).

As shown in FIG. 6, the basic setting is divided into a setting applied to the computer 10 being used and a setting applied to the computer 10 not being used. The former setting includes a setting item 211 for specifying the brightness of the screen, a setting item 212 for specifying the control method (automatic control or fixed control) of the CPU and a setting item 213 for specifying the processing speed of the CPU.

When a check mark is given to the check box of a setting item 224 of the basic setting, if any user's input operation is not performed for a fixed period of time, it is determined that the computer 10 is not used. Accordingly, the operation mode of the computer 10 is shifted to the power-saving mode corresponding to a suspended state (hibernation).

As shown in FIG. 7, the action setting includes a setting item 231 for specifying a process to be performed when the power button 14 is depressed, a setting item 232 for specifying a process to be performed when the computer is closed, a setting item 233 for specifying whether the operation mode is inhibited from shifting to the power-saving mode when the monitor (namely, display unit 12) is detached and for specifying the conditions required for the inhibition, and a setting item 234 for specifying a process to be performed when the monitor (namely, display unit 12) is detached.

When “yes” is specified in the setting item 233 of the action setting, the operation mode is inhibited from shifting to the power-saving mode when the display unit 12 is detached. When “under communication” is specified as a condition for the inhibition, if the computer 10 is communicating with the display unit 12 that is detached from the computer 10, the operation mode is inhibited from shifting to the power-saving mode. When “under communication or input operation” is specified, if no input operation is performed for a fixed period of time after the display unit 12 is detached or the main body 11 of the computer 10 is communicating with the detached display unit 12, the operation mode is inhibited from shifting to the power-saving mode. When “no conditions” is specified, if the display unit 12 is detached, the operation mode is inhibited from shifting to the power-saving mode irrespective of the communication state, the input operation state or the like.

When “Hyper Mode” is specified in the setting item 234 of the action setting, if the display unit 12 is detached from, the operation mode shifts to the hyper-mode for improving the performance of the CPU 111.

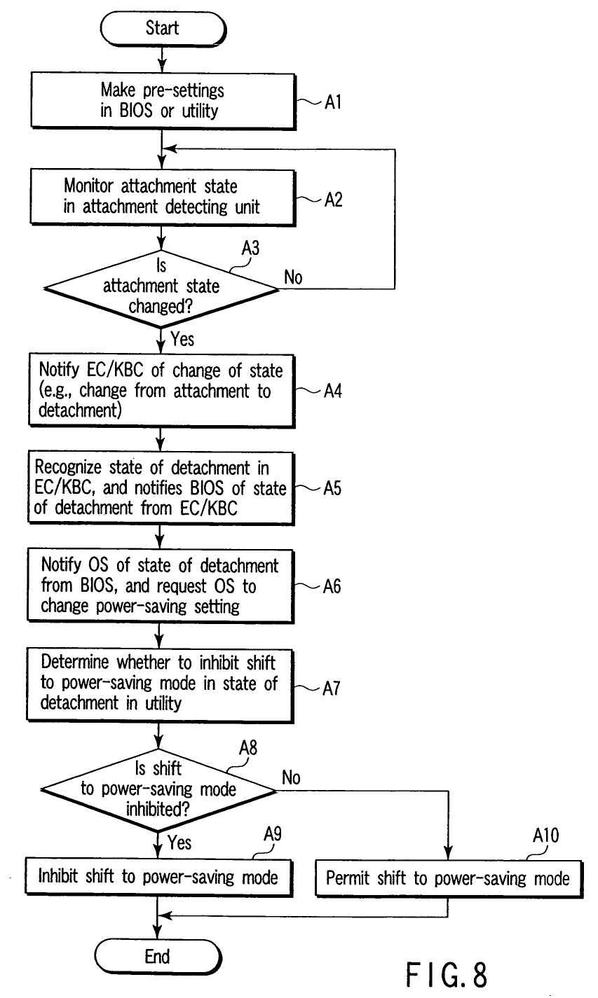

Referring next to the flowchart shown in FIG. 8, a first example of the operation performed when the display unit 12 is detached from the main body 11 of the computer 10 will be described. The operation of the first example is performed along the flow of the signal shown in FIG. 4A.

The BIOS or utility 200 sets the content to be specified by a user through the setting screen (block A1).

After the setting is completed, the attachment detecting unit 181 monitors a state of attachment/detachment of the display unit 12 to/from the main body 11 of the computer 10 (block A2). If there is no change in the state of attachment/detachment (No in block A3), the unit 181 continues to monitor the state. On the other hand, if there is a change in the state of attachment/detachment (e.g., a change in state from attachment to detachment) (Yes in block A3), the unit 181 supplies the EC/KBC 160 with a signal indicative of the detachment (block A4).

The EC/KBC 160 recognizes the change in state from attachment to detachment and supplies the BIOS 121 with information indicative of the detachment via a register or the like (block A5). If the BIOS 121 reads the information from the register or the like and recognizes the change to the detachment, it notifies the OS 122 of the change in state and requests the OS 122 to perform a necessary process (e.g., a change of the power-saving setting) (block A6).

The utility 200 managed by the OS 122 determines whether to inhibit the operation mode from shifting to the power-saving mode on the basis of the set content (the presence or absence of the specification of the inhibition, and the conditions for the inhibition) (block A7). If the utility 200 determines that the shift to the power-saving mode should be inhibited (Yes in block A8), the shift is inhibited (block A9). If the set content indicates the shift to the hyper mode, the shift is performed. On the other hand, if the utility 200 determines that the shift to the power-saving mode should not be inhibited (No in block A8), the shift is permitted (block A10).

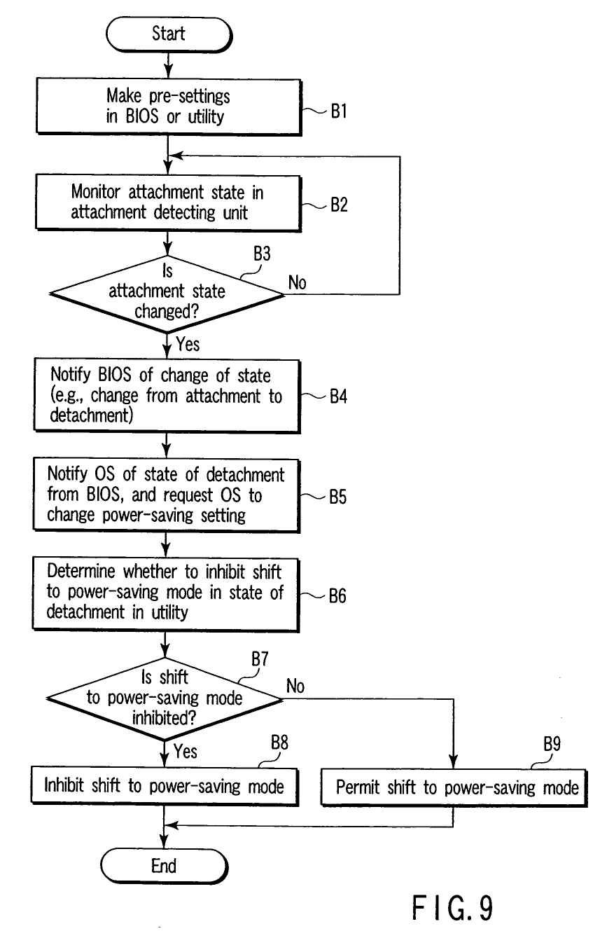

Referring next to the flowchart shown in FIG. 9, a second example of the operation performed when the display unit 12 is detached from the main body 11 of the computer 10 will be described. The operation of the second example is performed along the flow of the signal shown in FIG. 4B.

The BIOS or utility 200 sets the content to be specified by a user through the setting screen (block B1).

After the setting is completed, the attachment detecting unit 181 monitors a state of attachment/detachment of the display unit 12 to/from the main body 11 of the computer 10 (block B2). If there is no change in the state of attachment/detachment (No in block A3), the unit 181 continues to monitor the state. On the other hand, if there is a change in the state of attachment/detachment (e.g., a change in state from attachment to detachment) (Yes in block B3), the unit 181 supplies the BIOS 121 with information indicative of the detachment via the register or the like (block B4). If the BIOS 121 reads the information from the register or the like and recognizes the change to the detachment, it notifies the OS 122 of the change in state and requests the OS 122 to perform a necessary process (e.g., a change of the power-saving setting) (block B5).

The utility 200 managed by the OS 122 determines whether to inhibit the operation mode from shifting to the power-saving mode on the basis of the set content (the presence or absence of the specification of the inhibition, and the conditions for the inhibition) (block B6). If the utility 200 determines that the shift to the power-saving mode should be inhibited (Yes in block B7), the shift is inhibited (block B8). If the set content indicates the shift to the hyper-mode, the shift is performed. On the other hand, if the utility 200 determines that the shift to the power-saving mode should not be inhibited (No in block B7), the shift is permitted (block B9).

As described above, according to the present embodiment, when the display unit 21 is detached from the main body 11 of the computer 10, the shift to the power-saving mode is inhibited. Therefore, the power supply of the computer 10 is not turned off, but communication between the main body 11 and the display unit 12 can be prevented from being broken unexpectedly. When the display unit 12 is detached from the main body 11, the operation mode of the computer 10 is shifted to a mode (e.g., hyper mode) for improving the performance of the CPU 111. Consequently, the communication can be prevented from being broken, and good communication can reliably be maintained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a body to which a display unit is detachably connected, the body and the display unit having capabilities of mutually performing wireless communication in a detached state;
a processing unit to shift an operation mode of the electronic device to a power-saving mode; and
a control unit to inhibit the operation mode of the electronic device from shifting to the power-saving mode when the display unit is detached from the body.

2. The electronic device according to claim 1, further comprising a setting unit to allow a designation as to whether to inhibit the operation mode of the electronic device from shifting to the power-saving mode when the display unit is detached from the body.

3. The electronic device according to claim 1, wherein the control unit inhibits the operation mode of the electronic device from shifting to the power-saving mode if the body is communicating with the display unit that is detached from the body.

4. The electronic device according to the claim 1, wherein the control unit permits the operation mode of the electronic device to shift to the power-saving mode if no input operation continues to be performed for a fixed period of time and the body is not communicating with the display unit that is detached from the body.

5. The electronic device according to claim 1, further comprising a setting unit allowing for a designation of a condition for inhibiting the operation mode of the electronic device from shifting to the power-saving mode when the display unit is detached from the body.

6. The electronic device according to claim 1, wherein the control unit shifts the operation mode of the electronic device to a mode for improving performance of a processor when the display unit is detached from the body.

7. An operation control method applied to an electronic device including a body to which a display unit is detachably connected, the body and the display unit having capabilities of mutually performing wireless communication in a detached state, the method comprising:
monitoring whether the display unit is attached to or detached from the body; and
inhibiting an operation mode of the electronic device from shifting to a power-saving mode when the display unit is detached from the body.

8. The method according to claim 7, further comprising making a setting to determine whether to inhibit the operation mode of the electronic device from shifting to the power-saving mode when the display unit is detached from the body.

9. The method according to claim 7, wherein the operation mode of the electronic device is inhibited from shifting to the power-saving mode if the body is communicating with the display unit that is detached from the body.

10. The method according to claim 7, wherein the operation mode of the electronic device is permitted to shift to the power-saving mode if no input operation continues to be performed for a fixed period of time and the body is not communicating with the display unit that is detached from the body.

11. The method according to claim 7, further comprising making a setting to designate a condition for inhibiting the operation mode of the electronic device from shifting to the power-saving mode when the display unit is detached from the body.

12. The method according to claim 7, wherein the operation mode of the electronic device is shifted to a mode for improving performance of a processor when the display unit is detached from the body.
